(19) United States
(12) Patent Application Publication
(10) Pub. No.: US 2025/0148795 A1
(43) Pub. Date: May 8, 2025

(54) PALLET POSITIONING METHOD AND PALLET POSITIONING SYSTEM

(71) Applicant: DELTA ELECTRONICS, INC., Taoyuan City (TW)

(72) Inventors: Jan-Shian LIU, Taoyuan City (TW); Hao-Yu CHIEN, Taoyuan City (TW); Yi-Fu TIAN, Taoyuan City (TW); Yuan-Hsiang YANG, Taoyuan City (TW)

(21) Appl. No.: 18/812,817

(22) Filed: Aug. 22, 2024

Related U.S. Application Data
(60) Provisional application No. 63/595,963, filed on Nov. 3, 2023.

(30) Foreign Application Priority Data
Jul. 5, 2024 (CN) 2024108987072

(51) Int. Cl. G06V 20/52; G06T 7/13; G06V 10/24; G06V 20/64

(52) U.S. Cl. CPC G06V 20/52; G06T 7/13; G06V 10/247; G06V 20/64; G06V 2201/06; G06V 2201/12

(57) ABSTRACT

A pallet positioning method includes: defining a size parameter of a pallet; defining a pallet feature of the pallet according to the size parameter; obtaining an on-site image; defining a projection datum; calculating a projection plane coordinate based on the projection datum; transforming the on-site image to a perspective adjusted image according to the projection plane coordinate; obtaining a first pallet image in the perspective adjusted image according to the pallet feature; calculating an inclined angle of the first pallet image; rotating the first pallet image according to the inclined angle; obtaining a second pallet image; obtaining a position information of the pallet based on the second pallet image; and obtaining a three dimensional information of the pallet according to the inclined angle and the position information. A pallet positioning system is also disclosed.

### CROSS-REFERENCE TO RELATED APPLICATION

This patent application claims the benefit of U.S. Provisional Patent Application No. 63/595,963, filed Nov. 3, 2023, which is incorporated by reference herein.

### BACKGROUND OF THE DISCLOSURE

### Technical Field

The present disclosure relates to a positioning method and a positioning system, particularly relates to a pallet positioning method and a pallet positioning system.

### Description of Related Art

The present logistics industry generally adopts the pallet truck for transporting commodities. Even some of the pallet trucks are implemented with power device, operating personnel is still needed for operation. The transportation procedure with human intervention may have higher cost and lower safety, and the absolute precision and repetitive precision may not be able to achieve higher level.

Therefore, some enterprises introduce the automated guided vehicle (AGV) for automatically transporting the commodity pallet. The pallet positioning is mainly achieved by using binocular vision, laser, or RGB-D camera. However, binocular vision may be influenced by light and disadvantageous in the field without clear features, and RGB-D camera and high precision laser are expensive.

Thus, how to provide a pallet positioning method and a pallet positioning system, which may perform automatic positioning and reduce cost, is the problem that needs to be solved.

### SUMMARY OF THE INVENTION

The disclosure provides a pallet positioning method and a pallet positioning system, which may perform automatic positioning and reduce cost.

The disclosure provides a pallet positioning method including the steps of: defining a size parameter of a pallet; defining a pallet feature of the pallet according to the size parameter;

obtaining an on-site image; defining a projection datum in the on-site image; calculating a projection plane coordinate based on the projection datum; transforming the on-site image to a perspective adjusted image according to the projection plane coordinate; obtaining a first pallet image in the perspective adjusted image according to the pallet feature; calculating an inclined angle of the first pallet image; rotating the first pallet image according to the inclined angle; obtaining a second pallet image; obtaining a position information of the pallet based on the second pallet image; and obtaining a three dimensional information of the pallet according to the inclined angle and the position information.

In some embodiments, the rotating of the first pallet image according to the inclined angle includes: comparing the first pallet image being rotated and the pallet feature.

In some embodiments, the obtaining of the second pallet image includes: determining whether the second pallet image is corresponding to the pallet according to the size parameter and the pallet feature; and confirming that the second pallet image is obtained, if the second pallet image is determined to be corresponding to the pallet.

In some embodiments, the obtaining of the second pallet image further includes: comparing an edge distribution of the second pallet image and an edge distribution of the pallet feature; and aligning the edge distribution of the second pallet image and the edge distribution of the pallet feature.

In some embodiments, the position information is a two dimensional information

In some embodiments, the obtaining of the three dimensional information of the pallet according to the inclined angle and the position information includes: obtaining an inverse transformation matrix according to the inclined angle and the position information; and transforming the position information to the three dimensional information by using the inverse transformation matrix.

The disclosure further provides the other pallet positioning method including the steps of: defining a size parameter of a pallet; defining a pallet feature of the pallet according to the size parameter; obtaining an on-site image; defining a projection datum in the on-site image; calculating a projection plane coordinate based on the projection datum; transforming the on-site image to a perspective adjusted image according to the projection plane coordinate; performing a first positioning procedure to obtain a first pallet image in the perspective adjusted image; calculating an inclined angle of the first pallet image; rotating the first pallet image according to the inclined angle; obtaining a second pallet image; obtaining a position information of the pallet based on the second pallet image; and obtaining a three dimensional information of the pallet according to the inclined angle and the position information.

In some embodiments, the pallet positioning method further includes the step of: performing a second positioning procedure to the first pallet image being rotated to obtain the second pallet image.

In some embodiments, the second positioning procedure includes: comparing the first pallet image being rotated and the pallet feature.

In some embodiments, the obtaining of the second pallet image includes: determining whether the second pallet image is corresponding to the pallet according to the size parameter and the pallet feature; and confirming that the second pallet image is obtained, if the second pallet image is determined to be corresponding to the pallet.

In some embodiments, the obtaining of the second pallet image further includes: comparing an edge distribution of the second pallet image and an edge distribution of the pallet feature; and aligning the edge distribution of the second pallet image and the edge distribution of the pallet feature.

In some embodiments, the first positioning procedure includes: positioning the first pallet image in the perspective adjusted image according to the pallet feature.

The disclosure further provides the other pallet positioning system includes: a photographing module, obtaining an on-site image; an on-site constructing module, electrically connected with the photographing module, configured to receive the on-site image; and a positioning computation module, electrically connected with the on-site constructing module. The on-site constructing module includes: an input unit, configured to receive a size parameter of a pallet; and a constructing unit, electrically connected with the input unit, configured to define a pallet feature of the pallet according to the size parameter, define a projection datum in the on-site image, and calculate a projection plane coordinate based on the projection datum. The positioning computation module includes: a positioning unit, configured to transform the on-site image to a perspective adjusted image according to the projection plane coordinate, obtain a first pallet image in the perspective adjusted image according to the pallet feature, calculate an inclined angle of the first pallet image, rotate the first pallet image according to the inclined angle to obtain a second pallet image, and obtain a position information of the pallet based on the second pallet image; and a transforming unit, configured to obtain a three dimensional information of the pallet according to the inclined angle and the position information.

In some embodiments, the positioning unit is configured to compare the first pallet image being rotated and the pallet feature to obtain the second pallet image.

In some embodiments, the positioning unit is configured to determine whether the second pallet image is corresponding to the pallet according to the size parameter and the pallet feature, and confirm that the second pallet image is obtained, if the second pallet image is determined to be corresponding to the pallet.

In some embodiments, the positioning unit is configured to compare an edge distribution of the second pallet image and an edge distribution of the pallet feature, and align the edge distribution of the second pallet image and the edge distribution of the pallet feature to obtain the second pallet image.

In some embodiments, the transforming unit is configured to obtain an inverse transformation matrix according to the inclined angle and the position information, and transform the position information to the three dimensional information by using the inverse transformation matrix.

In summary, the pallet positioning method and the pallet positioning system of the disclosure obtain the on-site image, calculate the projection plane coordinate in the on-site image, and identify position and gesture of the pallet in the on-site image, with respect to the projection plane coordinate, according to defined size parameter and pallet feature of the pallet. Therefore, the pallet positioning method and the pallet positioning system of the disclosure may automatically position the pallet without the assistance of binocular vision. Further, the pallet positioning method and the pallet positioning system of the disclosure only need the photographing equipment, which may capture point cloud diagram or depth diagram, to process the positioning of the pallet, thus, the cost may be reduced and the equipment may be set up flexibly. Moreover, the pallet positioning method and the pallet positioning system of the disclosure adopt two dimensional (2D) manner to position the pallet and perform inclined angle estimation with respect to every pallet target. The pallet positioning method and the pallet positioning system of the disclosure may support multi-pallet positioning and obtain positions and gestures of all pallets. Also, the pallet positioning method and the pallet positioning system of the disclosure may perform multiple times of positioning with respect to the pallet image to obtain three dimensional (3D) information of the pallet in high precision.

Further, the pallet positioning method and the pallet positioning system of the disclosure may not need other additional information, such as 2D image, panoramic map, etc., and may precisely obtain the position of the pallet. Setup of the photographing module for capturing the point cloud diagram or depth diagram is more flexible due to performing coordinate estimation to the projection datum, which is calibrated to be related to the position of the pallet, during training. The projection datum may be, for example, calibration plate, ground, etc. As a result, setup of the photographing module may not be restricted by pitch (vertical position) and skew (horizontal position) between equipment and pallet. Moreover, the pallets in different distances have unified size and have no rotation angle based on the point cloud projection without pitch and skew. The scene complexity may be maximally decreased, and any kinds of positioning algorithm may be applied for positioning. The positioning tool may be flexibly and characteristically selected with respect to different types of photographing module.

### BRIEF DESCRIPTION OF THE DRAWINGS

FIG. 1 is the flowchart of the pallet positioning method in first embodiment of the disclosure.

FIG. 2 is the schematic diagram of the pallet template of the embodiment.

FIG. 3 is the schematic diagram of the on-site image of the embodiment.

FIG. 4A and FIG. 4B are the schematic diagrams of the procedure of obtaining the projection plane coordinate of the embodiment.

FIG. 5A and FIG. 5B are the schematic diagrams of the procedure of transforming the on-site image to the perspective adjusted image of the embodiment.

FIG. 6 is the schematic diagram of the first pallet image of the embodiment.

FIG. 7 is the schematic diagram of the second pallet image of the embodiment.

FIG. 8 is the schematic diagram of identifying all pallets in the perspective adjusted image of the embodiment.

FIG. 9 is the schematic diagram of the pallets after being identified of the embodiment.

FIG. 10 and FIG. 11 are the flowchart of the pallet positioning method in second embodiment of the disclosure.

FIG. 12 is the flowchart of the pallet positioning method in third embodiment of the disclosure.

FIG. 13 and FIG. 14 are the flowchart of the pallet positioning method in fourth embodiment of the disclosure.

FIG. 15 is the schematic diagram of the pallet positioning system of the disclosure.

### DETAILED DESCRIPTION

As used in the present disclosure, terms such as “first”, “second” are employed to describe various elements, components, regions, layers, and/or parts. These terms should not be construed as limitations on the mentioned elements, components, regions, layers, and/or parts. Instead, they are used merely for distinguishing one element, component, region, layer, or part from another. Unless explicitly indicated in the context, the usage of terms such as “first”, “second” does not imply any specific sequence or order.

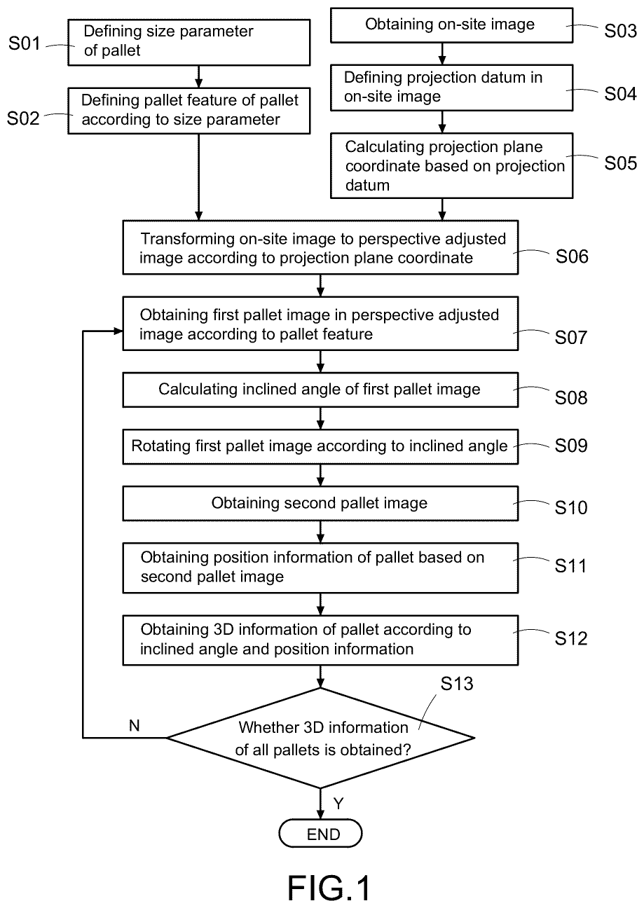

FIG. 1 is the flowchart of the pallet positioning method in first embodiment of the disclosure. As shown in FIG. 1, the pallet positioning method of the embodiment includes the step S01 to the step S13. The step S01 is defining the size parameter of the pallet. The step S02 is defining the pallet feature of the pallet according to the size parameter. The step S03 is obtaining the on-site image. The step S04 is defining the projection datum in the on-site image. The step S05 is calculating the projection plane coordinate based on the projection datum. The step S06 is transforming the on-site image to the perspective adjusted image according to the projection plane coordinate. The step S07 is obtaining the first pallet image in the perspective adjusted image according to the pallet feature. The step S08 is calculating the inclined angle of the first pallet image. The step S09 is rotating the first pallet image according to the inclined angle. The step S10 is obtaining the second pallet image. The step S11 is obtaining the position information of the pallet based on the second pallet image. The step S12 is obtaining the 3D information of the pallet according to the inclined angle and the position information. The step S13 is determining whether the 3D information of all pallets is obtained.

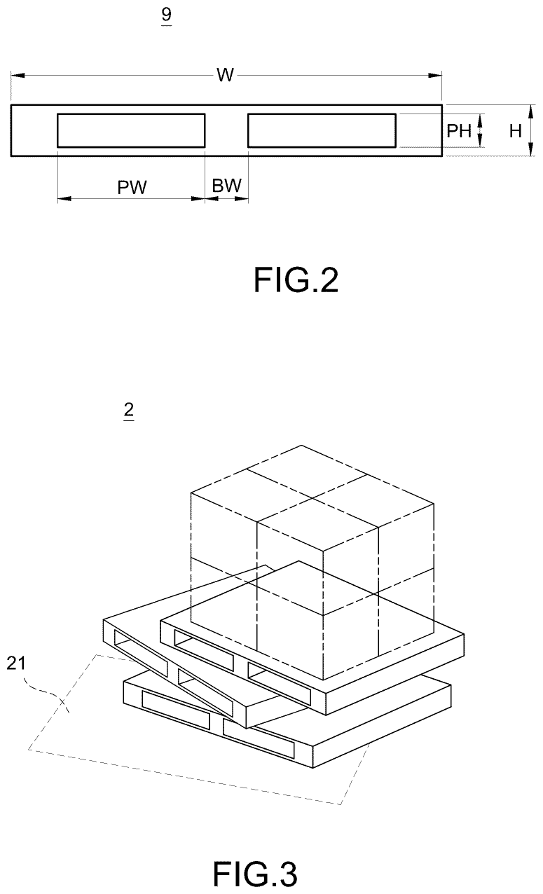

FIG. 2 is the schematic diagram of the pallet template of the embodiment. As shown in FIG. 1 and FIG. 2, in the step S01, the size parameter of the pallet is defined. In the step S02, the pallet feature of the pallet is defined according to the size parameter. First, the user may input the size parameter of the pallet that needs to be positioned or directly select the size parameter of the pallet from the database to construct the pallet template having predetermined pallet feature. It should be noted that the size parameter of the pallet in the embodiment mainly indicates the size parameter of one side of the pallet. The side is, for example, the side for AGV to identify, insert, and transport.

In some embodiments, the user may input, for example, the width W and height H of the pallet, width BW of interval region, and width PW and height PH of opening region, etc., the parameters are not limiting. The user may define the pallet feature of the pallet by the parameters, for example, the pallet has two opening regions, etc., for constructing the pallet template 9, the pallet feature of the pallet is not limiting. Of course, the user may flexibly decide which and what features that need to be constructed depending on different requirements.

FIG. 3 is the schematic diagram of the on-site image of the embodiment. Referring to FIG. 1 and FIG. 3, in the step S03, the on-site image 2 is obtained. In the step S04, the projection datum 21 is defined in the on-site image 2. Therefore, the user may use the photographing module with one optical axis (for example, time of flight (ToF) camera, here is not intended to be limiting) to face the pallet by any arbitrary angles to obtain the on-site image 2. The on-site image 2 may be, for example, the point cloud diagram or depth diagram, here is not intended to be limiting. Next, the user may define the projection datum 21 in the on-site image 2. In other words, the user may calibrate the projection datum 21, such as ground, related to the position where the pallet is disposed.

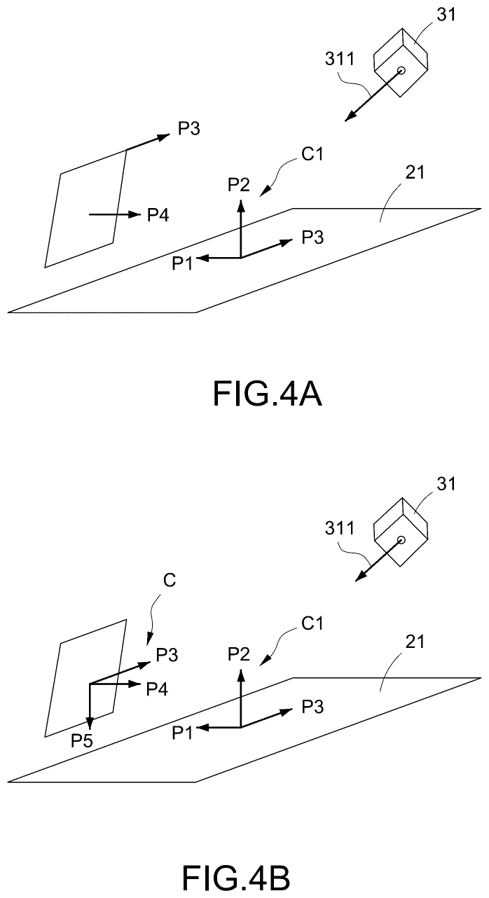

FIG. 4A and FIG. 4B are the schematic diagrams of the procedure of obtaining the projection plane coordinate of the embodiment. Referring to FIG. 1 and FIG. 4A, in the step S05, the projection plane coordinate C is calculated based on the projection datum 21. After the projection datum 21 (such as ground) is defined in the on-site image 2, the optical axis 311 of the photographing module 31 may be projected to the plane of the projection datum 21. Next, the 3D coordinate C1 of the projection datum 21 may be established by the optical axis projection vector P1, the normal vector P2 of the projection datum 21, and the cross-product vector P3 from cross product of the vectors P1 and P2. It is worth mentioning that the cross-product vector P3 is an intersection line of the optical axis projection plane and the plane of projection datum 21. Further, as shown in FIG. 4B, the cross-product vector P5 may be obtained from cross product of the inverse vector P4 of the optical axis projection vector P1 and the cross-product vector P3. The projection plane coordinate C is structured by the inverse vector P4, the cross-product vector P3, and the cross-product vector P5.

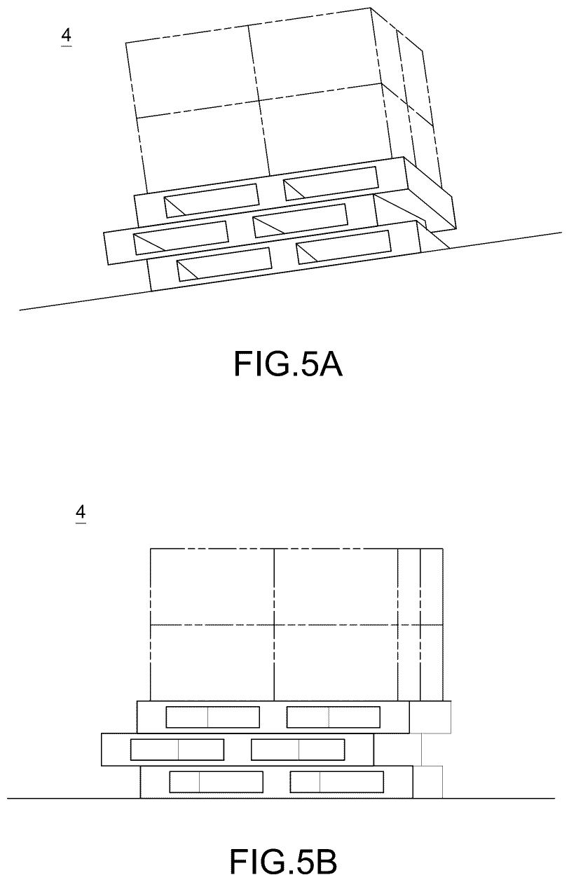

FIG. 5A and FIG. 5B are the schematic diagrams of the procedure of transforming the on-site image to the perspective adjusted image of the embodiment. Referring to FIG. 1, FIG. 5A, and FIG. 5B, in the step S06, the on-site image is transformed to the perspective adjusted image 4 according to the projection plane coordinate. Therefore, after the projection plane coordinate C (as shown in FIG. 4B) is obtained, the 3D on-site image 2 (as shown in FIG. 3) may be projected to the projection plane coordinate C. However, the image of the on-site image 2 being projected to the projection plane coordinate C may have pitch angle or skew angle (as shown in FIG. 5A). Therefore, the pitch angle and the skew angle may be adjusted based on the projection plane coordinate C and 3D coordinate C1 to transform the on-site image 2 into the perspective adjusted image 4 without pitch and skew (as shown in FIG. 5B). That is, for example, making the cross-product vector P5 of the projection plane coordinate C be parallel to the normal vector P2 of the 3D coordinate C1 (as shown in FIG. 4B) to obtain the perspective adjusted image 4 without pitch and skew.

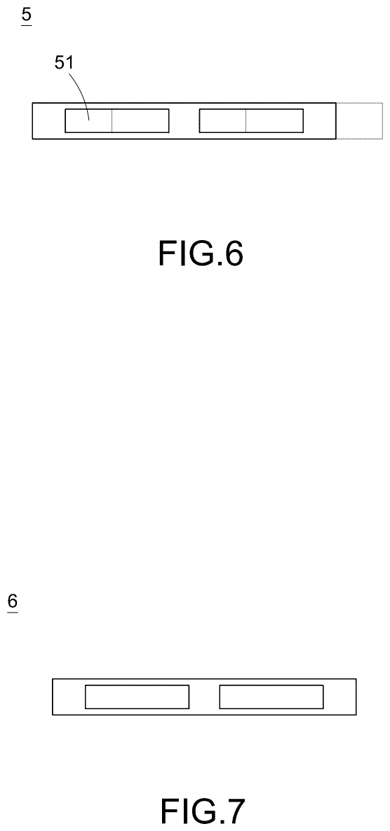

FIG. 6 is the schematic diagram of the first pallet image of the embodiment. Referring to FIG. 1, FIG. 5B, and FIG. 6, in the step S07, the first pallet image 5 is obtained in the perspective adjusted image 4 according to the pallet feature. Therefore, the first pallet image 5 may be identified and obtained from the perspective adjusted image 4 according to the pallet feature (as shown in FIG. 2) (may also be referred to the first positioning procedure). The perspective adjusted image 4 is the planar image of the 3D on-site image being projected to the projection plane, thus, the first pallet image 5 may include the inclined angle (for example, displayed as inclined portion 51) on horizontal direction (for example, toward left side or right side).

FIG. 7 is the schematic diagram of the second pallet image of the embodiment. Referring to FIG. 1, FIG. 6, and FIG. 7, in the step S08, the inclined angle of the first pallet image 5 is calculated. In the step S09, the first pallet image 5 is rotated according to the inclined angle. In the step S10, the second pallet image 6 is obtained. In the step S11, the position information of the pallet is obtained based on the second pallet image 6. In some embodiments, the position information is, for example, 2D information.

In order to calculate the inclined angle on horizontal direction of the first pallet image 5, the algorithm with higher allowable error may be adopted. For example, comparing samples approach may be used to calculate the inclined angle of the first pallet image 5, here is not intended to be limiting. The other algorithm used in positioning may also be applied depending on needs.

Taking comparing samples approach as an example, the algorithm is using artificial sample images or capturing one or multiple samples images from pallet image. Next, in the execution stage, the sample images are projected to every position on the first pallet image 5, and the similarities between every position on the first pallet image 5 and positions on the sample images are compared. In the comparing samples approach, the computation method such as normalized cross-correlation (NCC) algorithm (for example, the formula below) may be used, here is not intended to be limiting.

$$N C C = \frac{{\sum }_{i} ( {f}_{i} - {μ}_{f} ) ( {T}_{i} - {μ}_{T} )}{\sqrt{{\sum }_{i} {( {f}_{i} - {μ}_{f} )}^{2}} \sqrt{{\sum }_{i} {( {T}_{i} - {μ}_{T} )}^{2}}} = \frac{{\sum }_{i} ( {f}_{i} {T}_{i} ) - ( m {μ}_{T} {μ}_{f} )}{\sqrt{{\sum }_{i} ( {f}_{i}^{2} - m {μ}_{f}^{2} )} \sqrt{{\sum }_{i} {T}_{i}^{2}}}$$

fᵢ is pixel value of the first pallet image, μ_{f} is average value of the first pallet image in the block, Tᵢ is pixel value of the sample image, and μ_{T} is average value of the sample image.

After computation, if similarity is high, the position range may have high possibility to be the pallet, and the image range may be reserved to subsequent process for verification. Afterward, statistical algorithm, fitting algorithm, or gradient algorithm may be used to every position to estimate the inclined angle of the pixels on the first pallet image 5. Finally, the first pallet image 5 is rotated according to the inclined angle to correctly align the first pallet image 5 for obtaining the second pallet image 6. The second pallet image 6 is obtained from the forward information, such as projection, positioning, inclined angle, etc., thus, the position information of the pallet may be obtained by reversing all the steps. It is worth mentioning that the second pallet image 6 in FIG. 7 is used for calculating 2D information, such as the inclined angle, etc. As a result, the inclined angles of every pallet are obtained, and the front view image is useful for subsequent positioning or determination in higher precision manner. It should be noted that the second pallet image 6 may or may not be displayed. That is, the user may only observe the first pallet image 5 as shown in FIG. 6.

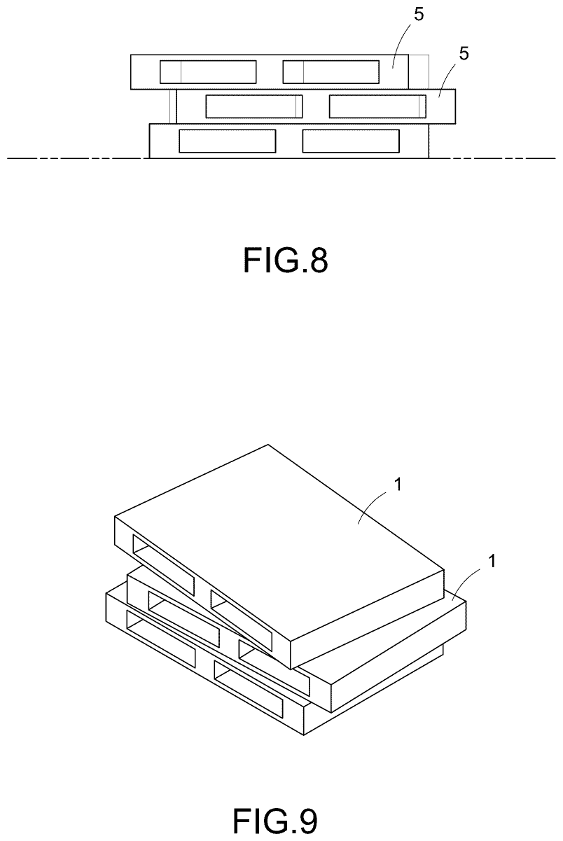

FIG. 8 is the schematic diagram of identifying all pallets in the perspective adjusted image of the embodiment. Specifically, the step S07 to the step S11 may be performed repeatedly until all of the first pallet images 5 (here is not intended to be limiting, the second pallet image may also be used for displaying) in the perspective adjusted image 4 (as shown in FIG. 5B) are identified. It should be noted that the amount of the pallet is not limiting.

FIG. 9 is the schematic diagram of the pallets after being identified of the embodiment. Referring to FIG. 1 and FIG. 9, in the step S12, the 3D information of the pallets is obtained according to the inclined angle and the position information. In some embodiments, the obtaining of the 3D information of the pallet according to the inclined angle and the position information further includes: obtaining an inverse transformation matrix according to the inclined angle and the position information; and transforming the position information to the three dimensional information by using the inverse transformation matrix. Finally, in the step S13, if the 3D information of all of the pallets is determined to be obtained, the process may be ended. On the other hand, if the 3D information of some pallets is determined to be not obtained, the process may return to the step S07 for further identifying.

As mentioned above, the position of the second pallet image 6 (as shown in FIG. 7) is obtained from the forward information, such as projection, positioning, inclined angle, etc., thus, the 3D information of every pallet 1 may be obtained by reversing the position information. In other words, when computing the projected second pallet image and the second pallet image that the inclined angle is correctly aligned, a 4×4 transformation matrix between before-transformation and after-transformation is obtained, and the coordinate points on the second pallet image may be reversed to the coordinate points on the original coordinate (such as the coordinate on the point cloud diagram) by calculating the inverse transformation matrix.

Further, during the positioning process of each pallet 1, the local coordinate (that is, coordinate of each pallet) is used to replace the global coordinate. Therefore, the last positioned coordinate needs to add an offset to be transformed into the global coordinate. The coordinate transformation matrix is described as below. First, a planar coordinate may be constructed by the inverse vector P4 (as shown in FIG. 4B) of the optical axis projection, the normal vector P2 (as shown in FIG. 4B) of the projection datum 21, and the cross-product vector of the vector P4 and the vector P2. The transformation matrix R between the coordinate of the TOF point cloud diagram and the planar coordinate is:

$$R = [ \begin{matrix}{{ToF}^{}}_{x} {x}_{plane} & {{ToF}^{}}_{y} {x}_{plane} & {{ToF}^{}}_{z} {x}_{plane} \\ {{ToF}^{}}_{x} {y}_{plane} & {{ToF}^{}}_{y} {y}_{plane} & {{ToF}^{}}_{z} {y}_{plane} \\ {{ToF}^{}}_{x} {z}_{plane} & {{ToF}^{}}_{y} {z}_{plane} & {{ToF}^{}}_{z} {z}_{plane}\end{matrix} ]$$

Moreover, apart from rotation relation, the projection further has shifting and zooming relation. Those are mainly transforming millimeter (mm) unit of point cloud diagram to pixel unit of image. X and Y of the projection image are obtained through subtracting minimum value (shifting) from the coordinate of the point cloud diagram and further dividing that by resolution (zooming). Z of the image further needs to add the distance ^{ToF} zₚₗₐₙₑ between the plane and the photographing module for indicating Z is on the plane. The calculating method is as below.

$${x}_{pixel} = \frac{1}{{resolution}_{x}} * ( {x}_{mm} - {x}_{mm}^{min} )$$

$${y}_{pixel} = \frac{1}{{resolution}_{y}} * ( {y}_{mm} - {y}_{mm}^{min} )$$

$${z}_{pixel} = \frac{1}{{resolution}_{z}} * ( {z}_{mm} - {z}_{mm}^{min} {+}^{ToF} {z}_{plane} )$$

The transformation matrix ^{mm}Tₚᵢₓₑₗ between pixel and millimeter may be integrated by aforementioned relation. The inverse transformation matrix may be obtained by multiplying the inverse matrix of transformation matrix R (indicating rotation relation) to the transformation matrix ^{mm}Tₚᵢₓₑₗ on the left side. The calculating method is as below.

$${mm}^{} {T}_{pixel} = [ \begin{matrix}{resolution}_{x} & 0 & 0 & {x}_{mm}^{min} \\ 0 & {resolution}_{y} & 0 & {y}_{mm}^{min} \\ 0 & 0 & {resolution}_{z} & {z}_{mm}^{min} {-}^{Tof} {z}_{plane} \\ 0 & 0 & 0 & 1\end{matrix} ]$$

$${T}^{- 1} = {[ \begin{matrix}{R}^{- 1} & O \\ O & 1\end{matrix} ]}^{mm} {T}_{pixel}$$

As a result, the 2D image as shown in FIG. 8 may be transformed according to the inclined angle and the position information. The position information is transformed to the 3D information by using the inverse transformation matrix to obtain the 3D information of the pallet 1 as shown in FIG. 9. That is, the information, such as the position and gesture, etc., in 3D space of the pallet 1 is obtained.

In summary, the pallet positioning method of the embodiment obtains the on-site image, calculates the projection plane coordinate in the on-site image, and identifies position (or location) and gesture of the pallet in the on-site image, with respect to the projection plane coordinate, according to defined size parameter and pallet feature of the pallet. Therefore, the pallet positioning method of the embodiment may automatically position the pallet without the assistance of binocular vision. Further, the pallet positioning method of the embodiment only needs the photographing equipment, which may capture point cloud diagram or depth diagram, to process the positioning of the pallet, thus, the cost may be reduced and the equipment may be set up flexibly. Moreover, the pallet positioning method of the embodiment adopts 2D manner to position the pallet and performs inclined angle estimation with respect to every pallet targets. The pallet positioning method of the embodiment may support multi-pallet positioning and obtain positions and gestures of all pallets. Also, the pallet positioning method and the pallet positioning system of the disclosure may perform multiple times of positioning with respect to the pallet image to obtain three dimensional (3D) information of the pallet in high precision.

Further, the pallet positioning method of the embodiment may not need other additional information, such as 2D image, panoramic map, etc., and may precisely obtain the position of the pallet. Setup of the photographing module for capturing the point cloud diagram or depth diagram is more flexible due to performing coordinate estimation to the projection datum, which is calibrated to be related to the position of the pallet, during training. The projection datum may be, for example, calibration plate, ground, etc. As a result, setup of the photographing module may not be restricted by pitch (vertical position) and skew (horizontal position) between equipment and pallet. Moreover, the pallets in different distances have unified size and have no rotation angle based on the point cloud projection without pitch and skew. The scene complexity may be maximally decreased, and any kinds of positioning algorithm may be applied for positioning. The positioning tool may be flexibly and characteristically selected with respect to different types of photographing module.

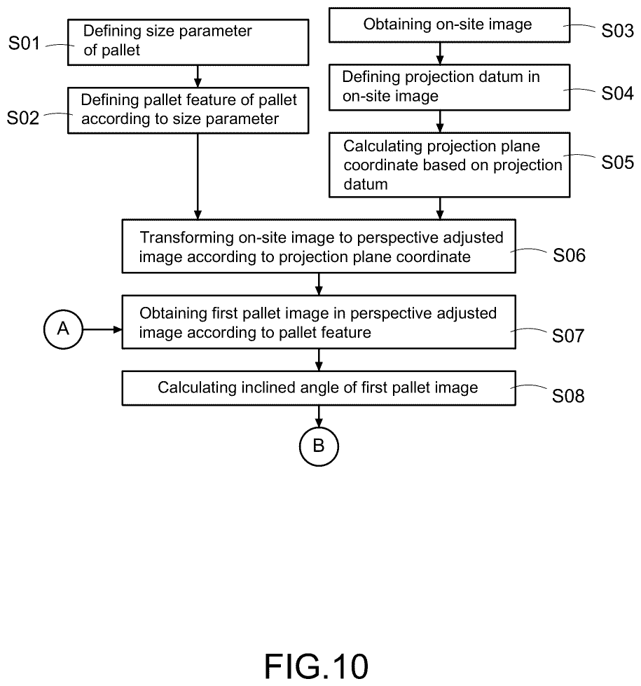

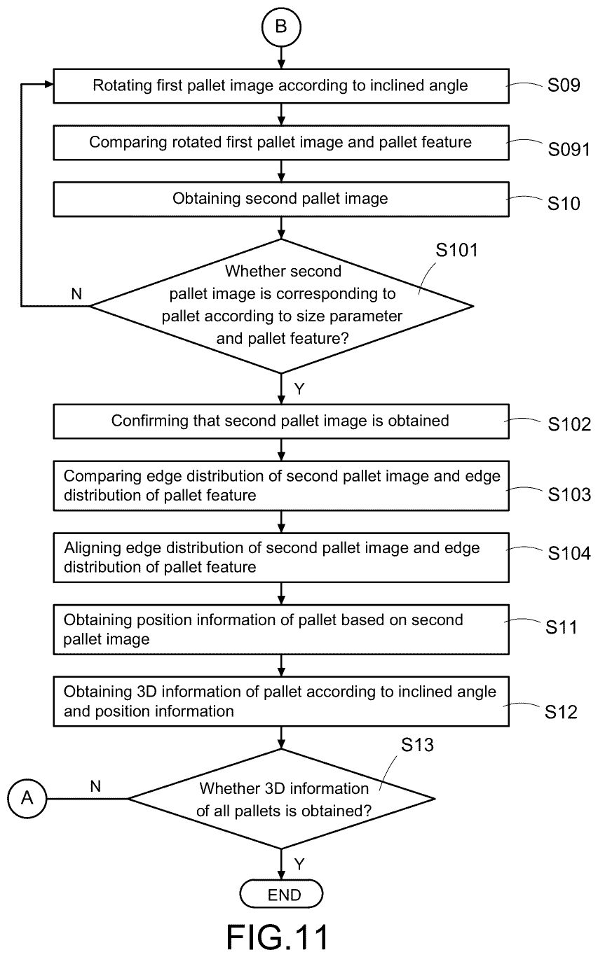

FIG. 10 and FIG. 11 are the flowchart of the pallet positioning method in second embodiment of the disclosure. As shown in FIG. 1, FIG. 10, and FIG. 11, the differences between the pallet positioning method in second embodiment and the pallet positioning method in first embodiment are that the pallet positioning method in second embodiment further includes the step S091 and the step S101 to the step S104. The step S091 is comparing the rotated first pallet image and the pallet feature (may also be referred to the second positioning procedure). The step S101 is determining whether the second pallet image is corresponding to the pallet according to the size parameter and the pallet feature. If the second pallet image is determined to be corresponding to the pallet, the step S102 is confirming that the second pallet image is obtained. The step S103 is comparing the edge distribution of the second pallet image and the edge distribution of the pallet feature. The step S104 is aligning the edge distribution of the second pallet image and the edge distribution of the pallet feature.

Specifically, after rotating the first pallet image according to the inclined angle in step S09, the pallet may be further positioned (step S091). The inclined angle of the first pallet image is correctly rotated, thus, in order to make the first pallet image be clearer and remove uncertainty in original image, a standard of higher similarity may be used for determining whether the image range is pallet to re-position the pallet.

For example, the positioning algorithm with higher precision, such as edge comparing, etc., may be used for comparing the pre-determined pallet feature with the first pallet image being correctly aligned to determine whether the two have similar edge distribution, and further align the edge points, here is not intended to be limiting. The edge distribution is related to high frequency information; thus, the precision is higher than comparing samples approach.

Further, after the second pallet image is obtained in the step S10, the pallet feature (that is, the size parameter, edge, connected region, etc., as shown in FIG. 2) of the pallet template may be further used for comparing the size, feature, etc., of each region in the second pallet image with the pre-set pallet feature to determine whether the two are consistent (step S101). If the second pallet image is determined to be corresponding to the pallet, the second pallet image is confirmed to be obtained for subsequent process. For example, the edge distribution of the second pallet image and the edge distribution of the pallet feature are compared and aligned (step S102 to step S104) for effectively eliminate erroneous determination (that is, false positive). On the other hand, if the second pallet image is determined to be not corresponding to the pallet, the process may be varied depending on setting, for example, the process may return to the step S07 for re-obtaining the first pallet image, or return to the step S09 for re-rotating the first pallet image to obtain the second pallet image, or the other different processes, here is not intended to be limiting.

In summary, the pallet positioning method of the embodiment may perform multiple times of positioning to the pallet image, and apply any kind of positioning algorithm for positioning to obtain the 3D information of the pallet with higher precision.

It should be noted that not all of the step S091 and the step S101 to the step S104 need to be performed. In other words, the process may only perform the step S091, or only perform the step S101 to the step S104.

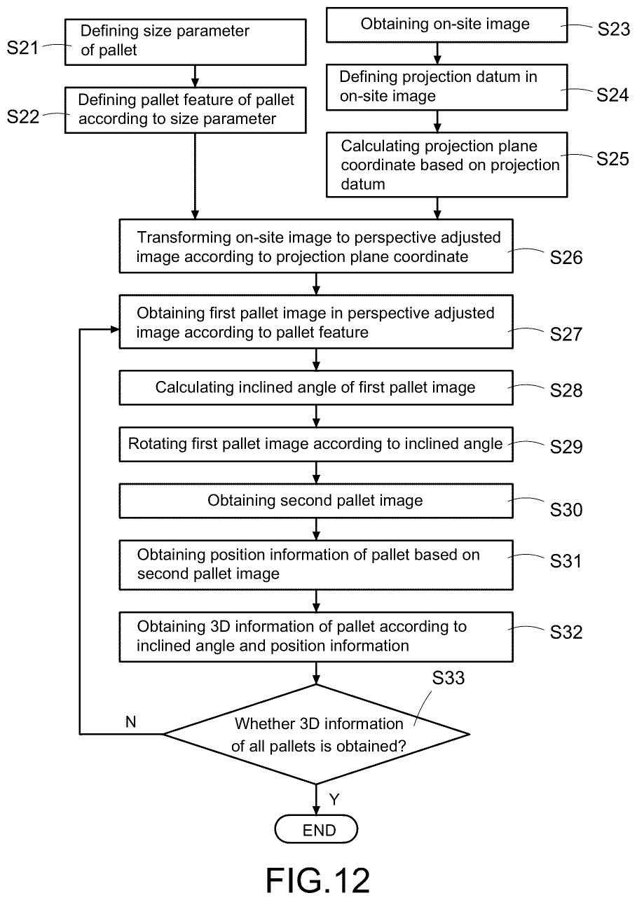

FIG. 12 is the flowchart of the pallet positioning method in third embodiment of the disclosure. As shown in FIG. 12, the pallet positioning method in third embodiment includes the step S21 to the step S33. The step S21 is defining the size parameter of the pallet. The step S22 is defining the pallet feature of the pallet according to the size parameter. The step S23 is obtaining the on-site image. The step S24 is defining the projection datum in the on-site image. The step S25 is calculating the projection plane coordinate based on the projection datum. The step S26 is transforming the on-site image to the perspective adjusted image according to the projection plane coordinate. The step S27 is performing the first positioning procedure to obtain the first pallet image in the perspective adjusted image. The step S28 is calculating the inclined angle of the first pallet image. The step S29 is rotating the first pallet image according to the inclined angle. The step S30 is obtaining the second pallet image. The step S31 is obtaining the position information of the pallet based on the second pallet image. The step S32 is obtaining the 3D information of the pallet according to the inclined angle and the position information. The step S33 is determining whether the 3D information of all pallets is obtained.

The pallet positioning method in third embodiment is similar to the pallet positioning method in first embodiment. The first positioning procedure includes positioning the first pallet image in the perspective adjusted image according to the pallet feature. As mentioned above, the specific description is described in the aforementioned embodiment, here is omitted for brevity.

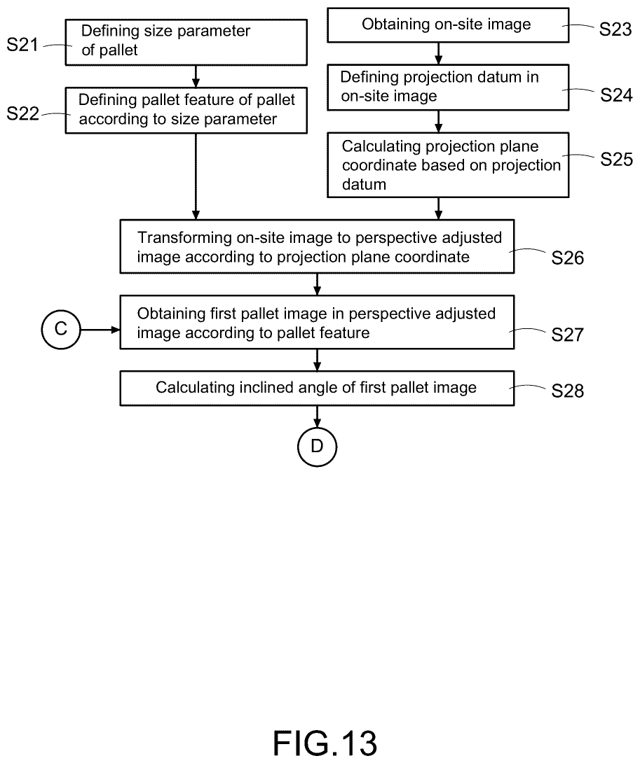

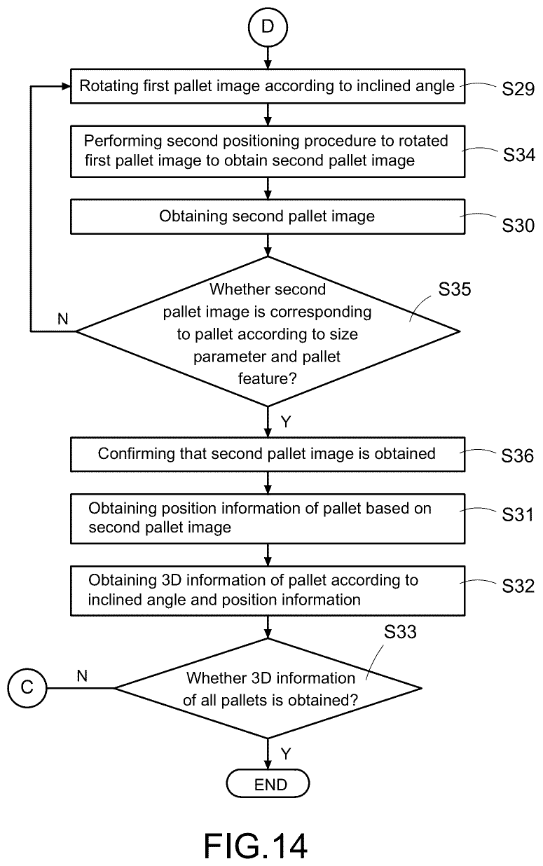

FIG. 13 and FIG. 14 are the flowchart of the pallet positioning method in fourth embodiment of the disclosure. As shown in FIG. 12 to FIG. 14, the differences between the pallet positioning method in fourth embodiment and the pallet positioning method in third embodiment are that the pallet positioning method in fourth embodiment further includes the step S34, the step S35, and the step S36. The step S34 is performing the second positioning procedure to the rotated first pallet image to obtain the second pallet image. The step S35 is determining whether the second pallet image is corresponding to the pallet according to the size parameter and the pallet feature. If the second pallet image is determined to be corresponding to the pallet, the step S36 is confirming that the second pallet image is obtained. The pallet positioning method in fourth embodiment is similar to the pallet positioning method in second embodiment. The second positioning procedure includes comparing the rotated first pallet image and the pallet feature. As mentioned above, the specific description is described in the aforementioned embodiment, here is omitted for brevity.

It should be noted that not all of the step S34, step S35, and step S36 need to be performed. In other words, the process may only perform the step S34, or only perform the step S35 and step S36.

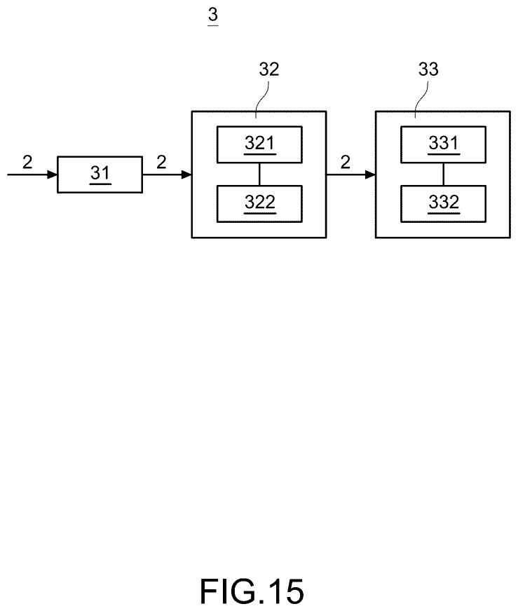

FIG. 15 is the schematic diagram of the pallet positioning system of the disclosure. The pallet positioning system 3 includes a photographing module 31, an on-site constructing module 32, and a positioning computation module 33. The photographing module 31 is, for example, using the photographing device with one optical axis, such as time of flight (ToF) camera, here is not intended to be limiting. The photographing module 31 may obtain the on-site image 2 (as shown in FIG. 3). The on-site constructing module 32 is electrically connected with the photographing module 31, and receives the on-site image 2. The on-site constructing module 32 may include an input unit 321 and a constructing unit 322. The input unit 321 may receive the size parameter of the pallet. The input unit 321 may be an input interface for the user to input the size parameter of the pallet, or may be a processing unit for reading and inputting the size parameter of the pallet from the storage. The constructing unit 322 is electrically connected with the input unit 321. The constructing unit 322 defines the pallet feature of the pallet according to the size parameter, defines the projection datum in the on-site image, and calculates the projection plane coordinate based on the projection datum.

The positioning computation module 33 is electrically connected with the on-site constructing module 32. The positioning computation module 33 may include a positioning unit 331 and a transforming unit 332. The positioning unit 331 may transform the on-site image to a perspective adjusted image according to the projection plane coordinate, obtain the first pallet image in the perspective adjusted image according to the pallet feature, calculate the inclined angle of the first pallet image, rotate the first pallet image according to the inclined angle to obtain the second pallet image, and obtain the position information of the pallet based on the second pallet image. The transforming unit 332 may obtain the three dimensional information of the pallet according to the inclined angle and the position information.

It is worth mentioning that the on-site constructing module 32 and the positioning computation module 33 may be, for example, performed by the same or different processors.

Further, the pallet positioning system 3 of the disclosure may perform the pallet positioning method as described in first embodiment to fourth embodiment, here is omitted for brevity. Further, the positioning unit 331 may, for example, perform the procedure of confirming the pallet image (the step S091 to the step S093, the step S101, and the step S102 in FIG. 10, or the step S27 in FIG. 11 and the step S34, the step S35, and the step S36 in FIG. 12, etc.), such as the first positioning procedure, the second positioning procedure, etc. The transforming unit 332 may, for example, perform the procedure of obtaining the inverse transformation matrix according to the inclined angle and the position information, and the procedure of transforming the position information to the 3D information by using the inverse transformation matrix.

In summary, the pallet positioning method and the pallet positioning system of the disclosure obtain the on-site image, calculate the projection plane coordinate in the on-site image, and identify position and gesture of the pallet in the on-site image, with respect to the projection plane coordinate, according to defined size parameter and pallet feature of the pallet. Therefore, the pallet positioning method and the pallet positioning system of the disclosure may automatically position the pallet without the assistance of binocular vision. Further, the pallet positioning method and the pallet positioning system of the disclosure only need the photographing equipment, which may capture point cloud diagram or depth diagram, to process the positioning of the pallet, thus, the cost may be reduced and the equipment may be set up flexibly. Moreover, the pallet positioning method and the pallet positioning system of the disclosure adopt two dimensional (2D) manner to position the pallet and perform inclined angle estimation with respect to every pallet target. The pallet positioning method and the pallet positioning system of the disclosure may support multi-pallet positioning and obtain positions and gestures of all pallets. Also, the pallet positioning method and the pallet positioning system of the disclosure may perform multiple times of positioning with respect to the pallet image to obtain three dimensional (3D) information of the pallet in high precision.

Further, the pallet positioning method and the pallet positioning system of the disclosure may not need other additional information, such as 2D image, panoramic map, etc., and may precisely obtain the position of the pallet. Setup of the photographing module for capturing the point cloud diagram or depth diagram is more flexible due to performing coordinate estimation to the projection datum, which is calibrated to be related to the position of the pallet, during training. The projection datum may be, for example, calibration plate, ground, etc. As a result, setup of the photographing module may not be restricted by pitch (vertical position) and skew (horizontal position) between equipment and pallet. Moreover, the pallets in different distances have unified size and have no rotation angle based on the point cloud projection without pitch and skew. The scene complexity may be maximally decreased, and any kinds of positioning algorithm may be applied for positioning. The positioning tool may be flexibly and characteristically selected with respect to different types of photographing module.

While this disclosure has been described by means of specific embodiments, numerous modifications and variations may be made thereto by those skilled in the art without departing from the scope and spirit of this disclosure set forth in the claims.

What is claimed is:

1. A pallet positioning method, comprising:
defining a size parameter of a pallet;
defining a pallet feature of the pallet according to the size parameter;
obtaining an on-site image;
defining a projection datum in the on-site image;
calculating a projection plane coordinate based on the projection datum;
transforming the on-site image to a perspective adjusted image according to the projection plane coordinate;
obtaining a first pallet image in the perspective adjusted image according to the pallet feature;
calculating an inclined angle of the first pallet image;
rotating the first pallet image according to the inclined angle;
obtaining a second pallet image;
obtaining a position information of the pallet based on the second pallet image; and
obtaining a three dimensional information of the pallet according to the inclined angle and the position information.

2. The pallet positioning method according to claim 1, wherein the rotating of the first pallet image according to the inclined angle comprises:
comparing the first pallet image being rotated and the pallet feature.

3. The pallet positioning method according to claim 1, wherein the obtaining of the second pallet image comprises:
determining whether the second pallet image is corresponding to the pallet according to the size parameter and the pallet feature; and
confirming that the second pallet image is obtained, if the second pallet image is determined to be corresponding to the pallet.

4. The pallet positioning method according to claim 3, wherein the obtaining of the second pallet image further comprises:
comparing an edge distribution of the second pallet image and an edge distribution of the pallet feature; and
aligning the edge distribution of the second pallet image and the edge distribution of the pallet feature.

5. The pallet positioning method according to claim 1, wherein the position information is a two dimensional information.

6. The pallet positioning method according to claim 1, wherein the obtaining of the three dimensional information of the pallet according to the inclined angle and the position information comprises:
obtaining an inverse transformation matrix according to the inclined angle and the position information; and
transforming the position information to the three dimensional information by using the inverse transformation matrix.

7. A pallet positioning method, comprising:
defining a size parameter of a pallet;
defining a pallet feature of the pallet according to the size parameter;
obtaining an on-site image;
defining a projection datum in the on-site image;
calculating a projection plane coordinate based on the projection datum;
transforming the on-site image to a perspective adjusted image according to the projection plane coordinate;
performing a first positioning procedure to obtain a first pallet image in the perspective adjusted image;
calculating an inclined angle of the first pallet image;
rotating the first pallet image according to the inclined angle;
obtaining a second pallet image;
obtaining a position information of the pallet based on the second pallet image; and
obtaining a three dimensional information of the pallet according to the inclined angle and the position information.

8. The pallet positioning method according to claim 7, further comprising:
performing a second positioning procedure to the first pallet image being rotated to obtain the second pallet image.

9. The pallet positioning method according to claim 8, wherein the second positioning procedure comprises:
comparing the first pallet image being rotated and the pallet feature.

10. The pallet positioning method according to claim 7, wherein the obtaining of the second pallet image comprises:
determining whether the second pallet image is corresponding to the pallet according to the size parameter and the pallet feature; and
confirming that the second pallet image is obtained, if the second pallet image is determined to be corresponding to the pallet.

11. The pallet positioning method according to claim 10, wherein the obtaining of the second pallet image further comprises:
comparing an edge distribution of the second pallet image and an edge distribution of the pallet feature; and
aligning the edge distribution of the second pallet image and the edge distribution of the pallet feature.

12. The pallet positioning method according to claim 7, wherein the first positioning procedure comprises:
positioning the first pallet image in the perspective adjusted image according to the pallet feature.

13. The pallet positioning method according to claim 7, wherein the position information is a two dimensional information.

14. The pallet positioning method according to claim 7, wherein the obtaining of the three dimensional information of the pallet according to the inclined angle and the position information comprises:
obtaining an inverse transformation matrix according to the inclined angle and the position information; and
transforming the position information to the three dimensional information by using the inverse transformation matrix.

15. A pallet positioning system, comprising:
a photographing module, obtaining an on-site image;
an on-site constructing module, electrically connected with the photographing module, configured to receive the on-site image, and comprising:
an input unit, configured to receive a size parameter of a pallet; and
a constructing unit, electrically connected with the input unit, configured to define a pallet feature of the pallet according to the size parameter, define a projection datum in the on-site image, and calculate a projection plane coordinate based on the projection datum; and
a positioning computation module, electrically connected with the on-site constructing module, and comprising:
a positioning unit, configured to transform the on-site image to a perspective adjusted image according to the projection plane coordinate, obtain a first pallet image in the perspective adjusted image according to the pallet feature, calculate an inclined angle of the first pallet image, rotate the first pallet image according to the inclined angle to obtain a second pallet image, and obtain a position information of the pallet based on the second pallet image; and
a transforming unit, configured to obtain a three dimensional information of the pallet according to the inclined angle and the position information.

16. The pallet positioning system according to claim 15, wherein the positioning unit is configured to compare the first pallet image being rotated and the pallet feature to obtain the second pallet image.

17. The pallet positioning system according to claim 15, wherein the positioning unit is configured to determine whether the second pallet image is corresponding to the pallet according to the size parameter and the pallet feature, and confirm that the second pallet image is obtained, if the second pallet image is determined to be corresponding to the pallet.

18. The pallet positioning system according to claim 17, wherein the positioning unit is configured to compare an edge distribution of the second pallet image and an edge distribution of the pallet feature, and align the edge distribution of the second pallet image and the edge distribution of the pallet feature to obtain the second pallet image.

19. The pallet positioning system according to claim 15, wherein the position information is a two dimensional information.

20. The pallet positioning system according to claim 15, wherein the transforming unit is configured to obtain an inverse transformation matrix according to the inclined angle and the position information, and transform the position information to the three dimensional information by using the inverse transformation matrix.
